(19) United States
(12) Patent Application Publication
(10) Pub. No.: US 2001/0013507 A1
(43) Pub. Date: Aug. 16, 2001

(54) Method for CMP of low dielectric constant polymer layers

(76) Inventors: Sharath D. Hosali, Glen Mills, PA (US); Vikas Sachan, Hockessin, DE (US)

Correspondence Address: Kenneth A. Benson, Rodel Holdings, Inc., Suite 1300, 1105 North Market Street, Wilmington, DE, 19899, US

(21) Appl. No.: 09/742,853

(22) Filed: Dec. 21, 2000

Related U.S. Application Data
(63) Continuation-in-part of application No. 09/505,042, filed on Feb. 16, 2000.
(60) Provisional application No. 60/120,567, filed on Feb. 18, 1999.

(51) Int. Cl. C23F 1/00; H01B 13/00

(52) U.S. Cl. 216/89; 216/97; 216/13; 216/17; 438/689

(57) ABSTRACT

A method for chemical-mechanical polishing of a low dielectric constant inorganic polymer surface such as an organo silicate glass wherein a slurry comprising high purity fine zirconium oxide particles uniformly dispersed in a stable aqueous medium is used.

This application is a continuation-in-part of application Ser. No. 09/505,042 filed Feb. 16, 2000 which claims the benefit of Provisional Application No. 60/120,567 filed Feb. 18, 1999.

### BACKGROUND OF THE INVENTION

1. Field of the Invention

The present invention relates generally to chemical mechanical polishing of multilayer semiconductor IC wafers, especially those comprising a low dielectric constant polymeric layer.

2. Description of Related Art

Semiconductor devices are fabricated step-by-step, beginning with a silicon wafer (substrate), implanting various ions, creating various circuit structures and elements, and depositing various insulating and conductive layers. Some of these layers are subsequently patterned by photoresist and etching, or similar processes, which results in topological features on the surface of the substrate. Subsequent layers over the topological layers sometimes duplicate the uneven topology of the underlying layers. Such uneven (irregular, non-planar) surface topology can cause undesirable effects and/or difficulties in the application of subsequent layers and fabrication processes.

Hence, it is known, at various stages of semiconductor fabrication, to planarize a layer. Various techniques for planarizing a layer by etching or chemical mechanical polishing (CMP) are known. Typically, CMP entails the circular motion of a wafer under a controlled downward pressure on a polishing pad saturated with a polishing slurry. For a more detailed explanation of chemical mechanical polishing, please see U.S. Pat. Nos. 4,671,851, 4,910,155 and 4,944,836, the specifications of which are incorporated herein by reference.

For example, U.S. Pat. No. 5,245,790 to Jerbic describes a technique for chemical mechanical polishing of semiconductor wafers using ultrasonic energy and a silica based slurry in a KOH solution. U.S. Pat. No. 5,244,534 to Yu et al. discloses a method of forming conductive plugs within an insulation layer. The process results in a plug of material, such as tungsten, which is more even with the insulation layer surface than that achieved using conventional plug formation techniques. Slurries of abrasive particles such as Al2O3 and etchants such as H2O2 and either KOH or NH4OH are used in the first CMP step to remove the tungsten at a predictable rate while removing very little of the insulation. The second CMP step utilizes a slurry consisting of an abrasive material, such as aluminum oxide, and an oxidizing component of hydrogen peroxide and water.

Similarly, U.S. Pat. No. 5,209,816 to Yu et al. teaches a CMP slurry comprising H3PO4, H2O2, H2O and a solid abrasive material while U.S. Pat. Nos. 5,157,876 and 5,137,544 to Medellin teach stress free CMP agents for polishing semiconductor wafers which include a mixture of water, colloidal silica and bleach containing sodium hypochlorite. U.S. Pat. No. 4,956,313 to Cote et al. discloses a slurry consisting of Al2O3 particulates, deionized water, a base and an oxidizing agent.

CMP slurry refers to the abrasive and etching chemicals. A silica-based slurry is “SC1” available from Cabot Industries. Other CMP slurries are based on silica and cerium (oxide), such as Rodel “WS-2000”, are available from Rodel, Inc., Newark, Del.

The term “colloidal” or “colloidally stable” means that the dispersion is question does not settle in a non-agitated state to an extent that renders the dispersion unusable as-is. In other words the utility for chemical mechanical polishing is available at any time, even after storage, or periods of non-use. Technically, those skilled in the art equate colloidal stability in a dispersion as “stable” where there are forces sufficient in the dispersion to overcome the van der Waals forces between the particles, as primary particles, aggregate particle, of a combination of both that may be present in the dispersion.

The aforementioned U.S. Pat. No. 4,910,155 discloses wafer flood polishing, and discusses polishing using 0.06 micron alumina particles in deionized water. The use of silica particulates is also discussed. Particulates of sizes as small as 0.006 microns (average size), and as large as 0.02 microns are discussed in this patent. The use of SiO2 particulates (average diameter of 0.02 microns) suspended in water is also discussed in this patent.

U.S. Pat. No. 4,956,313 discloses a via-filling and planarization technique. This patent discusses a planarization etch to remove portions of a dielectric surface lying outside of vias, while simultaneously planarizing a passivation layer, to provide a planarized surface upon which subsequent metal and insulator layers can be deposited. The use of an abrasive slurry consisting of Al2O3 particulates, de-ionized water, a base, and an oxidizing agent (e.g., hydrogen peroxide) is discussed, for etching tungsten and BPSG.

A multilevel metallized semiconductor integrated circuit (IC) typically includes conductive interconnections covered by interlayer dielectric material. Conventional interlayer dielectric materials include SiO2, and SiO2 doped with fluorine or boron, for example. In multilevel metallized integrated circuits, it is necessary to form conductive lines or similar structures above a previously formed structure. Global planarization of surface layers is necessary to ensure adequate focus depth during photolithography, as well as removing any irregularities arising during the various stages of the fabrication process.

Since CMP has been successfully used to polish oxide surfaces for a number of years, a recent trend in the semiconductor industry is to try to utilize CMP techniques and slurries for polishing low dielectric constant polymer surfaces. The chemical mechanical polishing of low dielectric constant polymer surfaces has not been well understood or developed. It would be advantageous to provide new methods for chemical mechanical polishing of low dielectric constant polymer surfaces in order to achieve the increasing need for multilevel schemes and low interconnect delays.

Accordingly, a need remains for improved chemical mechanical polishing techniques and slurries for the same which provide planarized ILD layers, free from undesirable contaminants and surface imperfections.

### SUMMARY OF THE INVENTION

It is an object of the present invention to provide an improved technique for polishing back or removing low dielectric constant polymer surfaces in semiconductor devices. Such layers are typically composed of parylenes, fluoro-polymers, polytetrafluoroethylene, aerogels, micro-porous polymers, and polyaryleneethers. There are also low dielectric constant inorganic polymers used in semiconductor devices such as carbon-doped silicon oxide which is considered an organo silicate glass (OSG) type of dielectric film.

It is a further object of the present invention to provide an improved technique for polishing back or removing layers in a semiconductor device as a prelude to reworking or repairing a defective layer in the device.

It is a further object of the invention to provide a technique for removing top layers of a semiconductor device, without damaging pre-existing topology, returning the wafer, undamaged, to a truly pre-existing state.

It is a further object of the present invention to provide an improved technique for chemical-mechanical polishing of semiconductor devices.

It is a further object of the present invention to provide an improved technique for CMP planarizing layers in semiconductor devices, including removing excess material such as metal overfilling vias.

It is a further object of the present invention to provide an improved technique for CMP polishing back or removing layers in semiconductor devices.

It is a further object of the present invention to provide an improved technique for CMP polishing back or removing layers in a semiconductor device as a prelude to reworking or repairing a defective layer in the device.

It is a further object of the invention to provide a technique for removing top layers of a semiconductor device, by CMP polishing, without damaging pre-existing topology, returning the wafer, undamaged, to a truly pre-existing state.

It is a further object of the invention to provide a technique for cleaning polishing residue from a semiconductor device which is compatible with the above-mentioned objects.

It is a further object of the invention to provide a technique for cleaning polishing residue from a semiconductor device which is compatible with the above-mentioned objects and which does not significantly erode the polished surface of the semiconductor device.

It is a further object of the invention to provide a technique for cleaning polishing residue from a semiconductor wafer which effectively removes both detritus (debris from the polished layer) and residual polishing slurry, without significantly attacking the polished (e.g., planarized) surface of the semiconductor device.

According to the invention, a low dielectric constant polymer surface on a semiconductor wafer is treated under CMP conditions with particular types of particles of Alumina (Al₂O₃), Silica (SiO₂), Titania (TiO₂), Zirconia (ZrO₂), Ceria (CeO₂), or mixtures thereof maintained in a colloidal suspension, and specified hereinbelow.

In a specific aspect, the present invention is directed to a process for chemical mechanical polishing low dielectric constant polymer surfaces on a semiconductor device with the use of high purity, fine metal oxide particles uniformly dispersed in a stable colliodal aqueous dispersion in a CMP process applied to the ILD layer. The process utilizes as the abrasive component, a stable colloidal dispersion of fine metal oxide particles that have a surface area ranging from about 40 m²/g to about 430 m²/g, an aggregate size distribution less than about 1.0 micron, and a mean aggregate diameter less than about 0.4 micron

### DETAILED DESCRIPTION OF THE INVENTION

The present invention is directed to a process for chemical mechanical polishing a low dielectric constant polymer surfaces using a slurry comprising high purity, fine metal oxide particles colloidally dispersed in an aqueous medium. The particles of the present invention exhibit a surface area ranging from about 40 m²/g to about 430 m²/g, an aggregate size distribution less than about 1.0 micron, and a mean aggregate diameter less than about 0.4 micron.

The surface area of the particles, as measured by the nitrogen adsorption method of S. Brunauer, P. H. Emmet, and I. Teller, J. Am. Chemical Society, Volume 60, Page 309 (1938) and commonly referred to as BET. The particles may comprise between 0.5% and 55% of the slurry depending on the desired rate of ILD material removal. The abrasion of the metal oxide particles, in turn, is a function of the particle composition, the degree of crystallinity and the crystalline phase, e.g. gamma or alpha for alumina. In order to achieve the desired selectivity and polishing rate, it has been found that the optimum surface area and loading level will vary depending upon which fine metal oxide particles are chosen for a particular polishing slurry, as well as the degree of crystallinity and phase of the particles.

In one embodiment when a high degree of selectivity is desired, solid loadings of less than 12% by weight for alumina particles having surface areas ranging from about 70 m²/g to about 170 m²/g is preferred. At lower surface areas, i.e. less than 70 m²/g, solid loadings of less than 7% is preferred for alumina particles. Similarly when a low selectivity is desired, it has been discovered that when the fine metal oxide particle is fumed silica, surface areas ranging between 40 m²/g and 250 m²/g should be present in a range from about 0.5% to about 20% by weight.

The metal oxide particles of the present invention are of a high purity and have an aggregate size distribution of less than about 1.0 micron in order to avoid scratching, pit marks, divots and other surface imperfections during the polishing. By way of example, FIGS. 2 and 3 illustrate aggregate size distributions for metal oxide particles of the present invention for fumed alumina and silica, respectively. High purity means that the total impurity content is typically less than 1% and preferably less than 0.01% (i.e. 100 ppm). Sources of impurities typically include raw material impurities and trace processing contaminants. The aggregate size of the particles refers to the measurement of the branched, three dimensional chains of fused primary particles (individual molten spheres).

The mean aggregate diameter refers to the average equivalent spherical diameter when using TEM image analysis, i.e. based on the cross-sectional area of the aggregate. The metal oxide particles used herein have a mean aggregate size distribution preferably less than 0.3 micron.

The aggregate size distribution of the colloidal dispersed particles can be determined by transmission electron microscopy (TEM) of metal oxide particles dispersed in a liquid medium where the agglomerates have been reversed to aggregates and concentration adjusted until discrete aggregates are shown on the TEM grid. Multiple fields on the grid are then imaged using an image analysis system manufactured by Kontron Instruments (Everett, Mass.) and an image analysis computer with a frame-grabber board for further processing, adjusting background and normalizing the image. Individual aggregates in the binary field are measured for a number of particle parameters, i.e. aggregate size, using known techniques such as that described in ASTM D3849-89

By stable colloidal dispersion is meant that the particle aggregates are isolated and well distributed throughout the medium and remain stable without agitation for at least a three months.

The metal oxide particles used in the present invention have an average or mean aggregate diameter of less than about 0.4 micron and for colloidal stability, the surface potential or the hydration force of the metal oxide particles is sufficient to repel and overcome the van der Waals attractive forces between the particles.

The particles used herein have a maximum zeta potential greater than ±10 millivolts. The zeta potential is dependent on the pH of the aqueous medium. In the process, for a given metal oxide particle composition, the preferred operating pH is above or below the point where the maximum zeta potential for that material occurs. It should be noted that the maximum zeta potential and isoelectric point are functions of the metal oxide composition and that the maximum zeta potential can be effected by the addition of salts to the aqueous medium. See R. J. Hunter, Zeta Potential in Colloid Science (Academic Press 1981). Zeta potential can be determined by measurement of the electrokinetic sonic amplitude using a Matec MBS-8000 instrument (available from Matec Applied Sciences, Inc., Hopkington, Mass.).

In another embodiment, oxide CMP may be simultaneously accomplished with the polishing slurry where the surface of metal vias is planarized with the ILD. For example, in the present invention, an oxidizing component is used to oxidize a metal via surface to its corresponding oxide. The via is mechanically polished to remove the oxide from the via. Although a wide range of oxidizing components may be used, preferred components include oxidizing metal salts, oxidizing metal complexes, iron salts such as nitrates, sulfates, EDTA, citrates, potassium ferricyanide and the like, aluminum salts, sodium salts, potassium salts, ammonium salts, quaternary ammonium salts, phosphonium salts, peroxides, chlorates, perchlorates, permanganates, persulfates and mixtures thereof. Typically, the oxidizing component is present in the slurry in an amount sufficient to ensure rapid oxidation of the metal via while balancing the mechanical and chemical polishing components of the slurry. Oxidizing components are typically present in the slurry from about 0.5% to 15% by weight, and preferably in a range between 1% and 7% by weight.

In order to further stabilize a polishing slurry against settling, flocculation and decomposition of the oxidizing component, a variety of additives, such as surfactants, polymeric stabilizers or other surface active dispersing agents, can be used. Many examples of suitable surfactants for use in the present invention are disclosed in, for example, Kirk-Othmer, Encyclopedia of Chemical Technology, 3rd Edition, Vol. 22 (John Wiley & Sons, 1983); Sislet & Wood, Encyclopedia of Surface Active Agents (Chemical Publishing Co., Inc., 1964) and available manufacturing literature, including for example McCutcheon's Emulsifiers & Detergents, North American and International Edition (McCutcheon Division, The MC Publishing Co., 1991); Ash, The Condensed Encyclopedia of Surfactants (Chemical Publishing Co., Inc. 1989); Ash, What Every Chemical Technologist Wants to Know About . . . Emulsifiers and Wetting Agents, Volume I (Chemical Publishing Co., Inc. 1988); Tadros, Surfactants (Academic Press, 1984); Napper, Polymeric Stabilization of Colloidal Dispersion (Academic Press, 1983); and Rosen, Surfactants & Interfacial Phenomena, 2nd edition (John Wiley & Sons, 1989), all of which are incorporated herein by reference. In one embodiment, a surfactant consisting of a copolymer of polydimethyl siloxane and polyoxyalkylene ether was found to be suitable.

In general, the amount of an additive used, such as a surfactant, in the present invention should be sufficient to achieve effective steric stabilization of the slurry and will typically vary depending on the particular surfactant selected and the nature of the surface of the particle.

As a result, additives like surfactants should generally be present in a range between about 0.001% and 10% by weight. Furthermore, the additive may be added directly to the slurry or treated onto the surface of the metal oxide particle utilizing known techniques. In either case, the amount of additive is adjusted to achieve the desired concentration in the polishing slurry.

The metal oxide particles of the present invention are typically precipitated aluminas, fumed silicas or fumed aluminas and preferably are fumed silicas or fumed aluminas. The production of fumed silicas and aluminas is a well-documented process which involves the hydrolysis of suitable feedstock vapor, such as silicon tetrachloride or aluminum chloride, in a flame of hydrogen and oxygen. Molten particles of roughly spherical shapes are formed in the combustion process, the diameters of which are varied through process parameters. These molten spheres of fumed silica or alumina, typically referred to as primary particles, fuse with one another by undergoing collisions at their contact points to form branched, three dimensional chain-like aggregates. The force necessary to break aggregates is considerable and often considered irreversible. During cooling and collecting, the aggregates undergo further collision that may result in some mechanical entanglement to form agglomerates. Agglomerates are thought to be loosely held together by van der Waals forces and can be reversed, i.e. de-agglomerated, by proper dispersion in suitable media.

The precipitated metal oxide particles may be manufactured utilizing conventional techniques and are typically formed by the coagulation of the desired particles from an aqueous medium under the influence of high salt concentrations, acids or other coagulants. The particles are filtered, washed, dried and separated from residues of other reaction products by conventional techniques known to those skilled in the art.

Once produced, the metal oxide is slowly added to deionized water to form a colloidal dispersion. The slurry is completed by subjecting the dispersion to high shear mixing using conventional techniques. The pH of the slurry is adjusted away from the isoelectric point to maximize colloidal stability. The polishing slurry used in the present invention can be a “one package” system (metal oxide particles and oxidizing component, if desired, in a stable aqueous medium) or “two package” system (the first package consists of the metal oxide particles in a stable aqueous medium and the second package consists of oxidizing component) with any standard polishing equipment appropriate for use on the desired low dielectric ILD surface of the wafer. The two package system is used for short shelf life oxidizers and the oxidizing component is added to the slurry just prior to polishing.

The polishing slurry of the present invention has been found useful in providing effective polishing to low dielectric constant polymer surfaces at desired polishing rates while minimizing surface imperfections and defects.

Particularly effective has been found the use of zirconia in a slurry for use in planarizing a semiconductor surface comprised of an organo silicate glass (OSG) such as a carbon-doped silicon oxide. Removal rates of OSG surfaces is enhanced by using a slurry comprised of zirconia as the abrasive versus the use of abrasive ordinarily used for CMP, such as alumina or silica. It has been shown experimentally that slurries comprising zirconia with a mean particle diameter of 50 to 150 nanometers can, under ordinary polishing machine conditions remove OSG surfaces at rates greater than 1000 Angstroms per minute while providing a surface roughness (rns) on the OSG surface of <5 Angstroms. Slurries of this invention may comprise from 0.01 to 20 wt. % of zirconia abrasive. More preferred is 0.1 to 10.0 wt. % and most preferred is 0.5 to 5.0 wt. %. The pH of the slurries may range from 1 to 11 with 1 to 6 more preferred and 1.5 to 5.0 most preferred.

As described herein, polishing slurries of the present invention have been found particularly useful in chemical mechanical planarization to remove uneven ILD topography, layers of material, surface defects including scratches, roughness, or contaminant particles such as dirt or dust. As a result, semiconductor processes utilizing this slurry experience an improvement in surface quality, device reliability and yield as compared to conventional etch back techniques. Although the fine metal oxide particles have been directed to aluminas and silicas, it is understood that the teachings herein have applicability to other fine metal oxide particles such as germania, ceria, titania and the like. Furthermore, the metal oxide particles may be utilized to polish other metal surfaces such as copper and titanium, as well as underlayers such as titanium, titanium nitride and titanium tungsten.

It is further understood that the present invention is not limited to the particular embodiments shown and described herein, but that various changes and modifications may be made without departing from the scope and spirit of the invention.

What is claimed is:

1. A process for chemical mechanical polishing a low dielectric constant inorganic polymer surface of an IC wafer, comprising the steps of:
(a) providing a chemical mechanical polishing slurry to the surface of said wafer, said slurry comprising a colloidally stable dispersion of zirconium oxide particles, said particles having a surface area ranging from about 40 m2/g to about 430 m2/g, an aggregate size distribution less than about 1.0 micron, and a mean aggregate diameter less than about 0.4 micron,
b) chemical mechanical polishing said low dielectric constant inorganic polymer surface on said wafer with said slurry.

2. The process of claim 1 wherein said low dielectric constant inorganic polymer surface is an organo silicate glass.

3. The process of claim 2 wherein said surface layer further comprising at least one via comprising a metal selected from the group consisting of tungsten, aluminum, copper, platinum, palladium, gold, iridium, and any combination or alloy thereof.

4. The process of claim 1 wherein said particles are present in a range between about 0.01% and 20% by weight.

5. The process of claim 4 wherein said particles are present in a range between about 0.1% and 10% by weight.

6. The process of claim 5 wherein said particles are present in a range between about 0.5% and 5% by weight.

7. The process of claim 1 wherein said slurry has a pH within the range of 1 to 11.

8. The process of claim 7 wherein said slurry has a pH within the range of 1 to 6.

9. The process of claim 8 wherein said slurry has a pH within the range of 1.5 to 5.

10. The process of claim 1 wherein said slurry further comprises a surfactant.

11. The process of claim 10 wherein the surfactant is selected from the group consisting of nonionic surfactants, anionic surfactants, cationic surfactants, amphoteric surfactants and mixtures thereof.

12. The process of claim 11 wherein said surfactant is selected from the group consisting of: polyalkyl siloxanes, polyaryl siloxanes, polyoxyalkylene ethers, and mixtures and copolymers thereof.
